(19) United States
(12) Patent Application Publication
(10) Pub. No.: US 2014/0067433 A1
(43) Pub. Date: Mar. 6, 2014

(54) Method and System for Insurance Claims Adjustment

(71) Applicant: David G. Hargrove, Graham, NC (US)

(72) Inventor: David G. Hargrove, Graham, NC (US)

(21) Appl. No.: 13/958,360

(22) Filed: Aug. 2, 2013

Related U.S. Application Data
(60) Provisional application No. 61/678,821, filed on Aug. 2, 2012.

(51) Int. Cl. G06Q 40/08

(52) U.S. Cl. CPC G06Q 40/08
USPC 705/4

(57) ABSTRACT

The invention relates to a system and method that allows for the labeling of images associated with a property damage insurance claim, the labels subsequently used to automatically generate documents associated with the claims adjustment process. More specifically, a claims adjuster uses a specialized interface to select sentence fragments and tags to generate labels for images and pictures of the insured's damaged property or to directly import into a claims estimating platform. The labels are then saved to a separate file and are later imported back into the program to be used to generate claims estimates, activity reports, and/or narratives. The invention automates and streamlines the claims adjustment process and provides the user with an all in one solution for documenting a claim and for creating the claims estimate and other documents needed to close the insurance claim. The system also allows an insured to access and enter information related to their policy or claims.

### CROSS REFERENCE TO RELATED APPLICATON

The present application claims benefit of priority to U.S. Prov. Pat. Application Ser. No. 61/678,821, filed Aug. 2, 2012, and entitled METHOD AND SYSTEM FOR INSURANCE CLAIMS ADJUSTMENT (Hargrove), which is hereby incorporated by reference herein in its entirety.

### FIELD OF THE INVENTION

The invention relates to a system and method that allows for the labeling of images associated with a property damage insurance claim, the labels subsequently used to automatically generate documents associated with the claims adjustment process. More specifically, a claims adjuster uses a specialized interface to select sentence fragments and tags to generate labels for images and pictures of the insured's damaged property or to directly import into a claims estimating platform. The labels are then saved to a separate file and are later imported back into the program to be used to generate claims estimates, activity reports, and/or narratives. The invention automates and streamlines the claims adjustment process and provides the user with an all in one solution for documenting a claim and for creating the claims estimate and other documents needed to close the insurance claim. The system also allows an insured to access and enter information related to their policy or claims.

### BACKGROUND OF THE INVENTION

The current insurance claims adjustment process is a time and labor intensive process that requires great attention to detail. The portion of the claims adjustment process done at the site of the damage or loss is done by a claims adjuster. Claims adjusters are those responsible for investigating, evaluating whether coverage exists, determining who is liable, and for determining damage related to a claim. An adjuster can be an employee of the insurer, an employee of an insurer-owned adjustment bureau or an independent adjuster retained either on a contract basis or on an individual adjustment basis. Adjusters are usually employed as field adjusters who operate outside the claims office or as inside adjusters who adjust claims from within the claims office. Field adjusters spend much of their time visiting the scene of a loss, interviewing witnesses and investigating damages. Due to the fact that most claims adjusters are required to spend a good deal of time away from the claims office in processing claims, it would be advantageous to reduce the number of trips the claims adjuster needs to make to the property to finish an estimate and close a claim.

There are several major steps involved in claims processing. The present invention relates to the loss appraisal and claims adjustment portion of the claims processing process. The claims adjustment process begins after an insured claimant's property is damaged. The claimant contacts his or her insurance company to report the damage to the insured property. The insurance company will verify the insurance coverage, create a claim file, and assign the claim to an insurance claims adjuster. After coverage has been verified, the file has been created, and once a claims adjuster has been assigned she will schedule and document an appointment to travel to the property to perform an assessment of the damage and create an estimate of the cost of the repairs.

Claims adjusting is the process of evaluating the reported damage to property and then determining what the fair settlement amount for the damage will be and reporting that amount in the form of an estimate. The field adjuster's job is to tell the story of what occurred during this loss to whoever may be reviewing it at the insurance company. The claims adjuster will investigate the facts related to the claim and will negotiate the cost of materials and services required to repair the damaged property and fulfill the claim. The claims adjuster will utilize different sources of information in the claims adjustment process including interviews with the claimant and other witnesses, photographs of the property, databases of cost estimates, databases of parts and components, prior claim files, and the claimant's insurance information.

An adjuster will usually take one or more pictures of the damaged property as a record for use in creating the estimate, activity report, and narrative. An adjuster's job is to take adequate pictures to support the estimate and prove the loss. Not only should damaged items should be photographed but items which may require some action during the repair process should be photographed as well. The adjuster will keep sufficient scope notes to accurately create the line item estimate which reflects any repairs that will need to be completed and are attributed to this loss. The adjuster will also keep adequate notes whether written or mental to depict all the facts collected surrounding this loss. The adjuster will enter these notes in one of a number of places within the claims documentation. I.E. (activity report, narrative, general loss report).

The estimate is not the only document that needs to be created by the claims adjuster. The current state of the art requires a claims adjuster to describe the scope of the damage, necessary repairs, and estimated costs two times. The claims adjuster must first take photos of the damaged portions of the property and annotate what is indicated in the photos. Then, the claims adjuster will re-write the same information a second time in the form of the estimate. Finally, the claims adjuster will “re-tell” the story of the damage and recommended repairs as a narrative and/or in the form of several activity reports. This multi-step process creates additional work for the claims adjuster and requires the claims adjuster to enter the same information several times, thereby increasing the time the claims adjuster must spend with each case and decreasing productivity.

The current available programs have no tool available for the adjuster to audit his estimates for carrier specific criteria. Additionally there are no provisions within the current software for an adjuster to track needed information such as scheduled appointments, additional required contact needed, contacts and phone #'s for a particular claim unless he opens that particular claim. There needs to be a single point of access to certain information for logistics and planning on all open claims.

Software currently exists that simplifies some aspects of the adjustment process. For example, software such as MSB IntegriClaim™ EyeQ®, Xactware® Xactimate®, Simultaneous Solutions SimSol 4.0™, and CCC Pathways® all give a claims adjuster access to large databases of cost estimates for individual items and their associated repair costs. The existing software also allows a claims adjuster to draw out a floor-plan for a house, take photos of the house, and associate the photos with the area of the house they represent. The existing software also allows for the creation of reports using some of the information previously entered by the claims adjuster. However, much of the information must be recorded several times because three separate documents, the picture annotations, the estimate, and the activity reports, must be generated. There is currently no system that allows a claims adjuster to enter information a single time and then re-use the information throughout the claims adjustment process.

What is needed is a system that allows a claims adjuster to easily find and enter information related to a specific claim once and then re-use the information throughout the claims adjustment process. By reducing the repetitive entry of the same data several times by the claims adjuster, a significant amount of time can be saved for the claims adjuster thereby improving both productivity and accuracy.

Furthermore, a system is needed that allows for greater consistency among documents in a claim file. Current systems implement a fragmented system of data entry that does not re-use previously entered data. A system that allows for easier selection, entry, and re-use of information into a claim file will improve consistency and accuracy and will make the claims adjustment process more efficient and effective.

### SUMMARY OF THE INVENTION

Accordingly there is need in the art for a system that allows insurance claims adjusters to easily input and re-use information to easily and automatically create the reports, estimates, and narratives needed to complete and close an insurance claim.

A general object of the invention is to provide a system and method for the accurate, efficient, and consistent creation of documents in the claims adjustment process. The present invention provides a system and method for easily inputting and re-using information in the insurance claims adjustment process through the use of common files and codes representing standardized sentence fragments from a caption library. A claims adjuster uses a direct input method and/or a console on the system to interact with the system and perform tasks including the input of data, labeling of pictures, and the creation of estimates and reports. The console is designed to assist the claims adjuster in meeting the increased demands placed on them by today's claims environment. The insurance carriers and insurance adjustment firm's demands have increased, requiring adjusters to create a greater level of documentation, input the data in multiple locations within a claim, shorten the cycle times for claims processing, or prepare this documentation in a format compatible for direct input into the insurance adjustment firm's systems and software. Additionally, carriers are looking for greater file consistency within an insurance claim. The console uses a unique way of entering the required information into a claim which allows the adjuster to meet the requirements in a much shorter time span.

In a first embodiment, the present invention provides for a computer-implemented method for processing property damage insurance claims, the method comprising: providing a user interface comprising a set of functions; associating a label with an individual image file using the set of functions, the label comprising a description of the image file; sorting the label in a separate file; receiving additional information related to the image file and appending the additional information to the separate file; and automatically generating at least one document comprising the information in the separate file. Further aspects of this embodiment include wherein the additional information comprises at least one of scheduling information, claimant information, activity documentation, or repair options. The set of functions for associating a label with an individual image file may include a library of standardized sentence fragments and tags. In addition, the separate file may be exported for use in a separate portion of the computer program or in a separate computer program and the at least one document may be one of a claim estimate, activity report, or narrative. The method may further comprise automatically generating a set of scheduling information comprising at least the information in the separate file. Further, the at least one document may be formatted for an individual insurance carrier.

In a second embodiment, the present invention provides a system having a server, and a computer comprising a processor, a memory, and a database, the system comprising: a display means for providing a user interface comprising a set of functions; the computer configured to: allow a user to associate a label with an individual image file using the set of functions, the label comprising a description of the image file; store the label in a separate file; receive additional information related to the image file and append the additional information to the separate file; automatically generate at least one document comprising the information in the separate file; and the database configured to store the separate file and the at least one document. Further aspects of this embodiment include wherein the additional information comprises at least one of scheduling information, claimant information, activity documentation, or repair options. The set of functions for associating a label with an individual image file may include a library of standardized sentence fragments and tags. In addition, the separate file may be exported for use in a separate portion of the computer program or in a separate computer program and the at least one document may be one of a claim estimate, activity report, or narrative. The method may further comprise automatically generating a set of scheduling information comprising at least the information in the separate file. Further, the at least one document may be formatted for an individual insurance carrier.

In one embodiment the invention uses a task menu to access different areas of a system console to be used in the claims estimation and documentation process. The claims documentation process begins when pictures taken at the claims site are labeled using pre-defined statements or sentence fragments that are stored in the system. The pre-defined statements could be either sentence fragments or shortened codes and can either be stored in the system at the time of installation or later defined by a user. These pre-defined statements, or words, form a library of terms linked to expanded text for use in the activity report and narrative report used to document claims information. The words are linked to a database with the expanded text by a code which may be a common code used in existing claims estimation software.

There are two ways that the pictures can be labeled using the system. First, labeling data can be entered before the pictures are taken and the labeling data can be stored into a file which can later be imported by the user into other portions of the system or used in later steps in the claims process. This allows the user to make annotations about a picture before the picture file is available. Second, the pictures can be labeled as they are taken and stored in the system and the labeling data can be directly input into the system for use in the claims adjustment process without first being stored to a separate file. As the user is annotating the photos for the damage they indicate, the user is prompted by the system with repair options for the type of damage indicated by the user. The user selects the type of repair necessary for the situation and that selection is added to either a file with the picture annotations for later use or is used directly in the program in the preparation of the insurance claim. All line item annotations and comments, repair options, and quantities of items that need repairs are stored to a file and/or selected to be directly imported during the automated claims estimate creation process. The descriptions of damaged items, location information for damaged items, repair recommendations, and any other information recorded during the initial annotation process is saved to a file to be later imported into the claims activity report, claims narrative, or other areas of the claim file. Preferably, this information is stored directly in a database for easy storage, access, lookup, and cross reference in the same or later application, but the information can also be stored in a plain text or rich text file.

The user then documents other aspects of the claim activity. The user is prompted to input information regarding a number of different aspects of the claim during the documentation of the claim activity. The user is required to enter information regarding the insured's gender, name, contractor's name and number, date and time of appointments, and any other information that may be required to complete the documentation of the claim. This information is stored as variables to be used during other portions of the claims adjustment process or may be used in other claims operations. A record of all scheduling documentation and organizational information, such as call-back lists, is automatically created during the user's entry of the claims activity documentation.

The information saved to a file during the picture labeling and claim documentation process can now be imported back into the system for use in creating activity or narrative reports. The same information that was used in creating the activity and narrative reports may also be imported for use in a claims estimation platform. The user is also prompted to enter any additional information that was not entered in the earlier picture labeling or claims documentation process that is necessary for the completion of the information needed for the claims estimate.

These functions can be modified by the user to produce a series of steps that will provide for carrier specific audits. The carrier specific audits may be necessary to product estimates, narratives, and activity reports that conform to the requirements of specific insurance carriers or insurance adjustment firms. The customized steps and reports will ensure that the carrier specific audit conforms to the insurance carrier's specific guidelines. A carrier audit portal can also be provided to allow access to pre-prepared customized forms and information process flows for carrier specific audits.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a simplified network diagram of the components involved in the system.

FIG. 2 is a flowchart of the steps followed in the method of the invention.

FIG. 3 is a screenshot of a menu that allows for access to different areas of the console.

FIG. 4 is a screenshot of the interface that allows for the selection of labeling data to be stored to file.

FIG. 5 is a screenshot of the interface that allows for adding labeling data directly to pictures.

FIG. 6 is a screenshot of an automatic prompt generated to allow the user to select a repair type.

FIG. 7 is a screenshot of the interface that stores all selections made up to this point in the process to be stored to file and used in later report generation.

FIG. 8 is a screenshot of the interface that allows for the input of additional information to be stored to file and used in later report generation.

FIG. 9 is a screenshot of the interface for the input of additional information needed for proper documentation of the claims activity.

FIG. 10 is a screenshot of the interface used for viewing and creating scheduling documentation and other organizational activity.

FIG. 11 is a screenshot of the interface used to import and edit information previously saved to file for use in report generation.

FIG. 12 is a screenshot of the interface used for estimate creation.

FIG. 13 is a screenshot of a specialized menu that allows the user access to carrier specific audits.

FIG. 14 is a flowchart depicting an embodiment of the invention whereby a user may input additional information using a web interface.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

The present invention provides a system and method for easily entering, processing, and managing information related to the insurance claims adjustment process to be used in the creation of activity and narrative reports and insurance claims estimates. The information handled by the system includes pictures or graphic representations of the property subject to the claim, descriptions of the property and damage, captions for the pictures and graphic representations, insurance policy information, accounts of the incident that led to the property damage, parties' contact information, and any other information needed in the claims adjustment process.

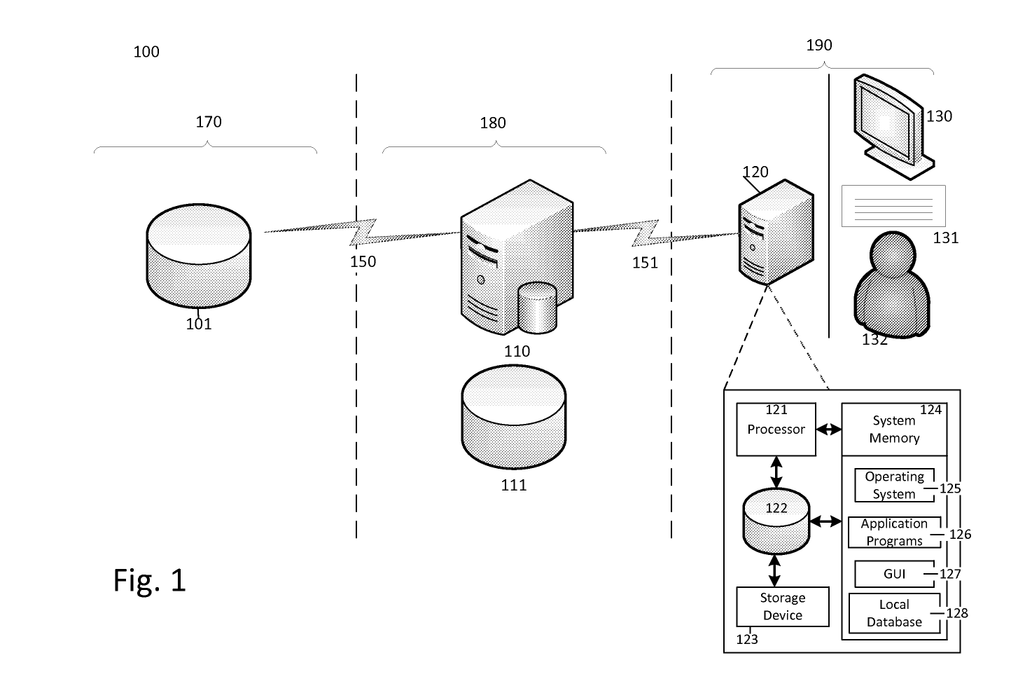

Referring now to FIG. 1, the claimed process may be carried out in conjunction with the combination of hardware and software and communications networking illustrated in the form of exemplary system 100. The system 100 is provided for the input and re-use of information by the user 132 in the insurance claims adjustment process. The system 100 is composed of three sub-systems: user system 190; server system 180; and remote database 170.

In the user system 190 the user 132 interacts with the system via user interface device 131. User interface device 131 may be a keyboard and mouse, touch interface, or any other interface device that allows the user 132 to interact with the system. The user interface is displayed on display device 130. In the preferred embodiment display device 130 is a LCD or CRT monitor, but may also be a touch screen interface or other display device capable of displaying the system interface. The system interface is run and stored on user computer 120. User computer 120 connects to primary server 110 via network connection 151. Primary server 110 is locally connected to server database 111 and may also be connected to a remote database 101. Server database 111 contains information needed by the user 132 to complete the insurance claims adjustment process but is not stored on user computer 120. Remote database 101 contains information that is even less frequently used, such as specific data needed for carrier specific audits, and may be accessed through network connection 150.

Still referring to FIG. 1, in the preferred embodiment, user computer 120 is a desktop computer, but in other embodiments may be a mobile device, such as a cell phone, tablet computer, handheld computer or the like, that may comprise a typical combination of hardware and software including, as shown in respect to user computer 120, system memory 124, operating system 125, application programs 126, graphical user interface (GUI) 127, processor 121, database 122, and storage 123. The primary server 110 in this example may comprise a typical combination of hardware and software including, in respect to primary server 110, system memory, operating system, graphical user interface (GUI), processor, and storage. The methods and systems of the present invention, described in detail hereafter, may be employed in providing remote users access to a searchable server database 111. In particular, remote users may access the server database using requests for information needed to complete the insurance claims adjustment process. Client side application software may be stored on machine-readable medium and comprising instructions executed, for example, by the processor 121 of user computer 120, and presentation of the interface through display device 130 facilitates the interaction between user computer 120 and primary server 110. The operating system 125 should be suitable for use with the system 100 and functionality described herein, for example, OSX, Windows operating system, Linux, or the like. The system may require the remote user or client machines to be compatible with minimum threshold levels of processing capabilities, minimal memory levels and other parameters.

The configuration thus described in this example is one of many and is not limiting as to the invention. System 100 may include a network of servers, computers and databases, such as over one or more LAN, WLAN, Ethernet, token ring, FDDI ring or other communications network infrastructures shown as network connections 150 and 151. Any of several suitable communication links are available for network connections 150 and 151, such as one or a combination of wireless, LAN, WLAN, ISDN, X.25, DSL, and ATM type networks, for example. Software to perform functions associated with system 100 may include self-contained applications within a desktop or server or network environment and may utilize local databases, such as SQL 2005 or above or SQL Express, IBM DB2 or other suitable database, to store documents, collections, and data associated with processing such information. In the exemplary embodiments the various databases may be a relational database. In the case of relational databases, various tables of data are created and data is inserted into, and/or selected from, these tables using SQL, or some other database-query language known in the art. In the case of a database using tables and SQL, a database application such as, for example, MySQL™, SQLServer™, Oracle 81™, 10G™, or some other suitable database application may be used to manage the data. These tables may be organized into an RDS or Object Relational Data Schema (ORDS), as is known in the art.

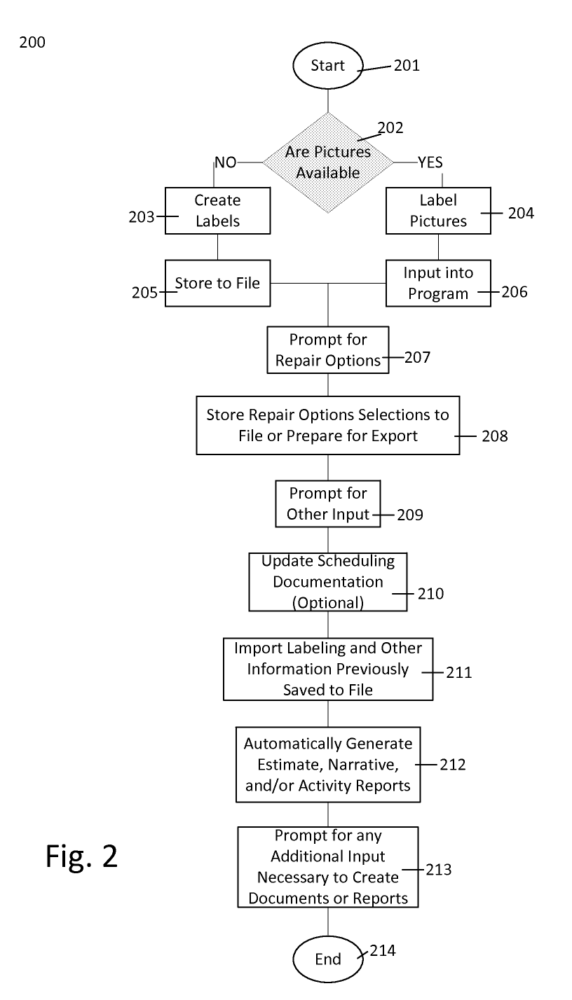

Now referring to FIG. 2, a flowchart shows the process 200 provided for entering information needed for the insurance claims adjustment process and for creating all documents needed to complete an insurance claim. When the process begins at 201 the system first needs to determine if pictures of the damaged property that is the subject of the insurance claim are available at step 202. If pictures of the property are available then the pictures are labeled by the user at step 204. After the pictures have been labeled at step 204, the pictures are with their respective labels are imported into the program used to create the reports and estimate at step 206. If the pictures are not available at the start of the process, placeholder labels are created in step 203 that may or may not contain full descriptions. These labels are then saved to a file in step 205 that may be imported into the program later when the pictures are available.

After the labels have been created, the system will automatically prompt the user at step 207 to select the repair option required for the specific type of damage to the property. This is the first step in the documentation of the activity. The repair option selected is then stored to a file at step 208 for later use in generating reports and estimates. In another embodiment, the information is instead prepared to be imported into another program, such as a claims estimating platform, or another portion of the same program. The user may select some or all of the information to be directly imported, and if necessary, the information is formatted or made compatible with an other program. Once the repair option has been selected and stored, the user is then prompted at step 209 to input any additional information needed for the claims adjustment process that has not already been entered or saved to file. Prompts to the user could include additional damaged items, location information, other repair recommendations, insured's gender, insured's name, contractor's name and number, date and time of appointments, and other information needed to complete the claims adjustment process. In one embodiment, at step 210 scheduling documentation and organization information may be automatically updated using the information entered and saved in the prior step. However, this documentation is normally input during the initial customer contact while creating an activity report.

Once the activity documentation is complete, information previously saved to file, including the pictures and their labels, are imported or loaded back into the system at step 211. The documentation, scheduling information, pictures, labels, and other information entered by the user in the prior steps is then used by the system in step 212 to automatically generate the narrative and activity reports required for the claims process. The user may then enter any additional information needed to create the final estimate that was not already entered in the prior steps at step 213.

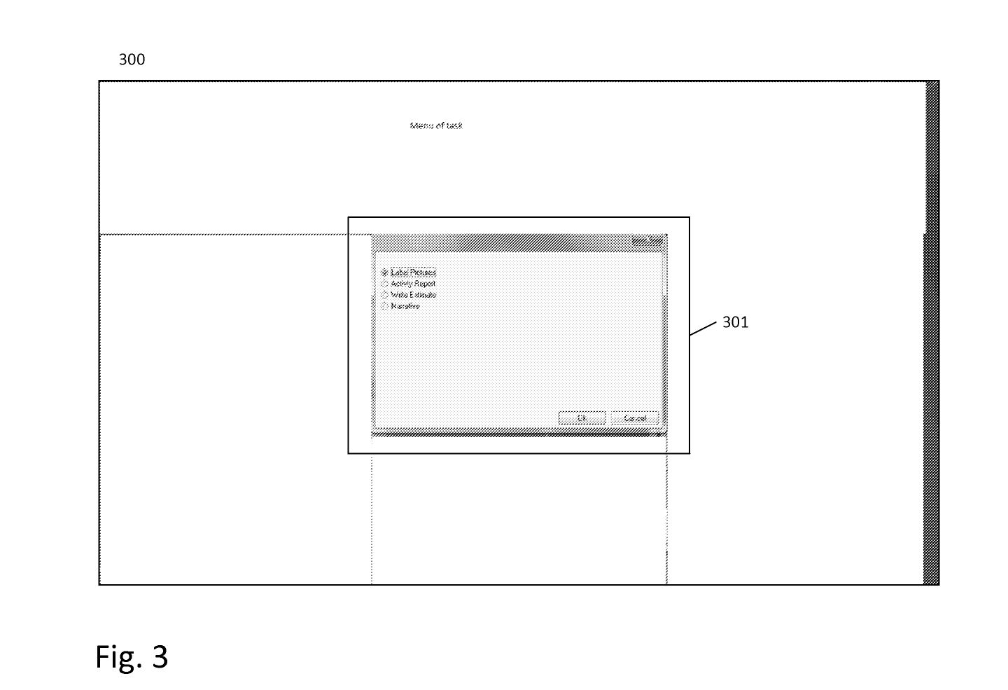

FIGS. 3 through 13 provide screenshots depicting the interface used to complete the steps described in FIG. 2. With reference to FIG. 3, a menu 301 in the interface 300 is provided to allow the user to select the task the user wishes to complete. The user may select from, for example, labeling pictures, generating an activity report, writing an estimate, and generating a narrative. Additional options may also be provided.

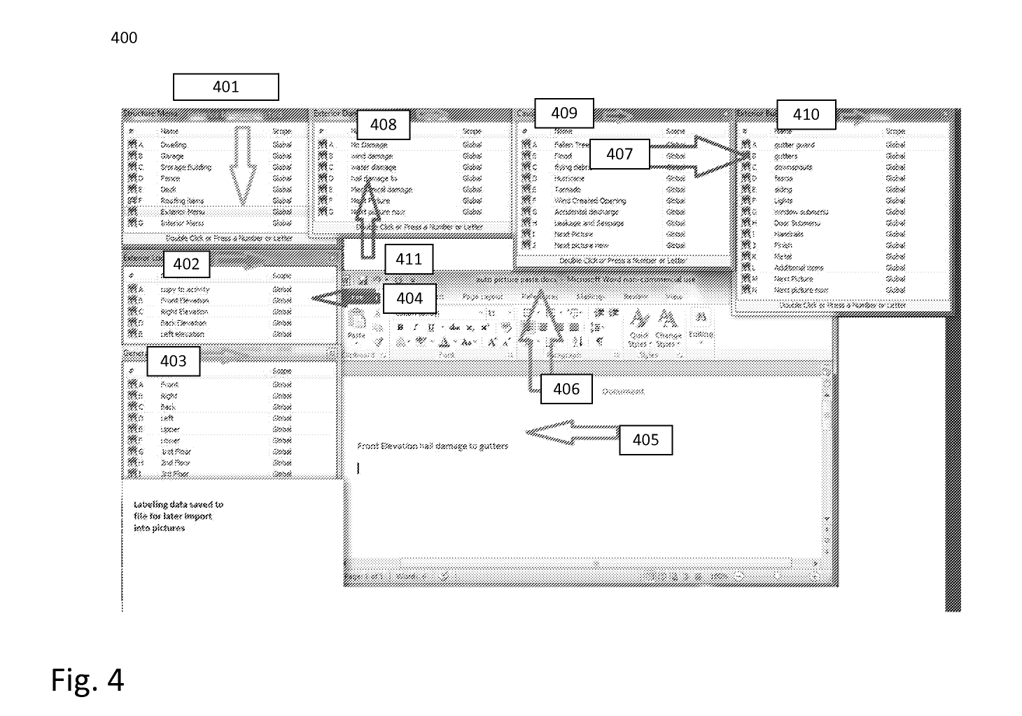

With reference now to FIG. 4, an interface 400 is provided to allow for standardized labeling of pictures taken to document the damage to the insured's property. Interface 400 would be displayed to the user if pictures of the insured's damaged property are not available when the user is creating the labels. Structure menu 401 allows the user to select the area of the property that has been damaged. The user could select from, for example, dwelling, garage, storage building, fence, deck, roofing items, exterior items, or interior items. In this screenshot, the user has selected Exterior Menu from the structure menu 401. Once the user has selected an item from menu 401, a number of other menus and menu items 402, 403, 408, 409, and 410 are contextually presented to the user. These menu items are presented based on the item selected from structure menu 401. Exterior Location menu 402, and Exterior Damage Type menu 408 are examples of pre-defined statements to be selected by the user to generate a label for the picture the user is describing. Menus 402, 403, 408, 409, and 410 all contain standardized sentence fragments that, when selected by the user, are combined in document 406 to form a sentence to be used as a label for the picture being described. The label as generated from the selected menu items is shown to the user in data field 405. Selected items front elevation 404, hail damage to 411, and gutters 407 can all be seen in data field 405.

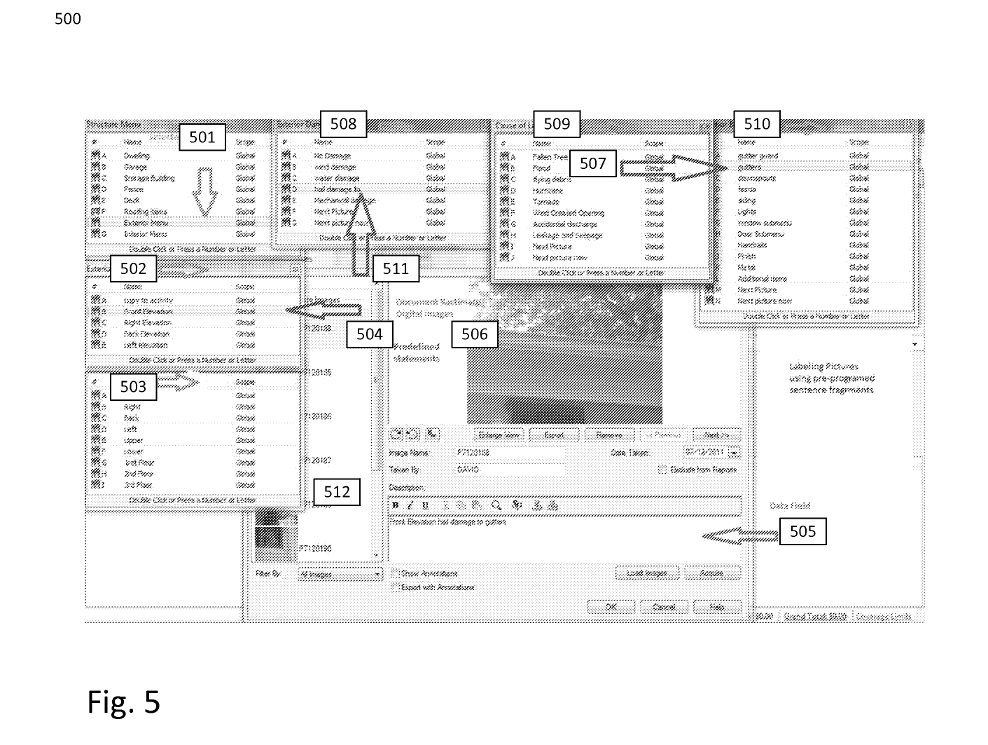

With reference now to FIG. 5, an interface 500 is provided to allow for standardized labeling of pictures taken to document the damage to the insured's property if the pictures are available when the user is creating the labels. The interface 500 contains many similar elements to interface 400 in FIG. 4, such as menus 501, 502, 503, 508, 509, and 510. However, when the user selects a menu item from Structure menu 501, and subsequently selects items from the menus 502, 503, 508, 509, and 510, the selections are not displayed in a data field in a document to be saved to file. Instead, the picture 506 being labeled is displayed directly in the interface, and the selections of sentence fragments from the menu lists are turned into a label that is stored in picture description 505. In this example, selections 504 front elevation, 511 hail damage to, and 507 gutters are combined to form the label in the picture description 505. If the user selects a different picture from the list of images 512, the menus 502, 503, 508, 509 and 510 will be reset and will be contextually generated once the user selects new menu option from Structure menu 501.

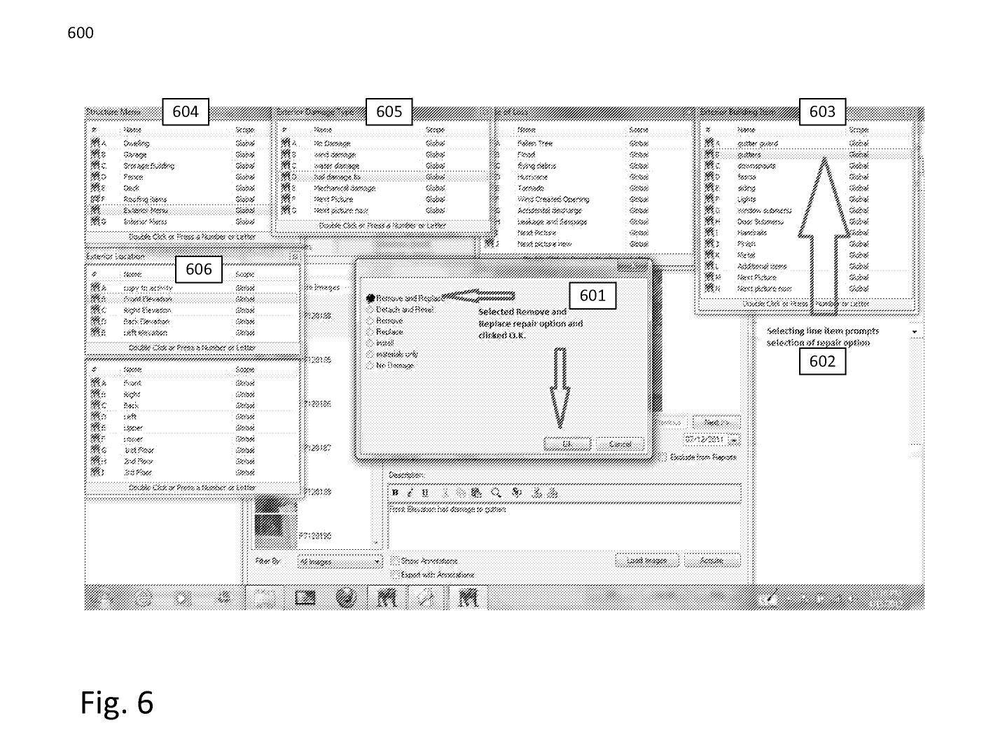

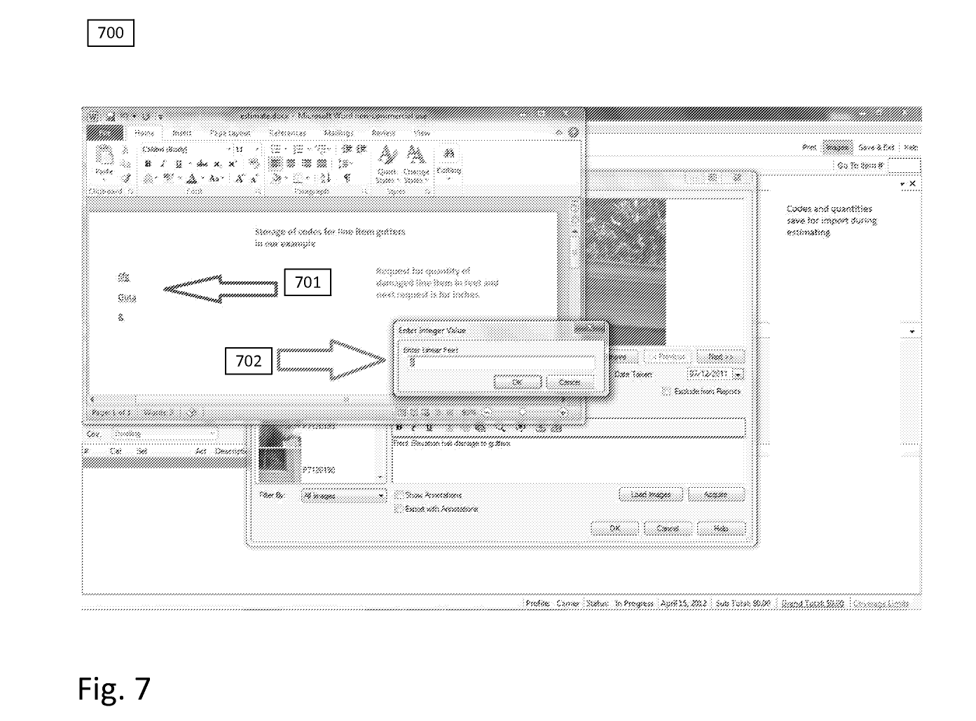

With reference now to FIG. 6, the interface 600 shows a specialized prompt 601 that is displayed when the user selects a specific building item 602 from the Exterior Building Item menu 603. In this example the user has already selected “Exterior Menu” from Structure Menu 604, “Front Elevation” from Exterior Location 605, and “hail damage to” from Exterior Damage Type menu 606. When the user selects the specific item damaged from Exterior Building Item menu 603, in this example selection 602 gutters, the prompt 601 is then automatically generated and displayed to the user. The user selects the appropriate repair type for the selection 602 from the prompt 601 which is then sent to a file, shown in FIG. 7, where the user is then prompted to enter additional information.

With reference now to FIG. 7, after the user has selected an item from menu 603 in FIG. 6 and has selected a repair option from the prompt 601 the user will be directed to interface 700. The user's repair selection from prompt 601 will be used to generate prompts to the user for additional input based on the user's selection in prompt 601. In this example the user is prompted to enter the number of linear feet of gutter to be replaced in prompt 702 as they had selected “Remove and Replace” from prompt 601 with respect to the exterior building item “gutters”. The user's prior repair selections and additional inputs are shown in file 701 where they can be saved and stored for later import to be used for automatic estimate creation.

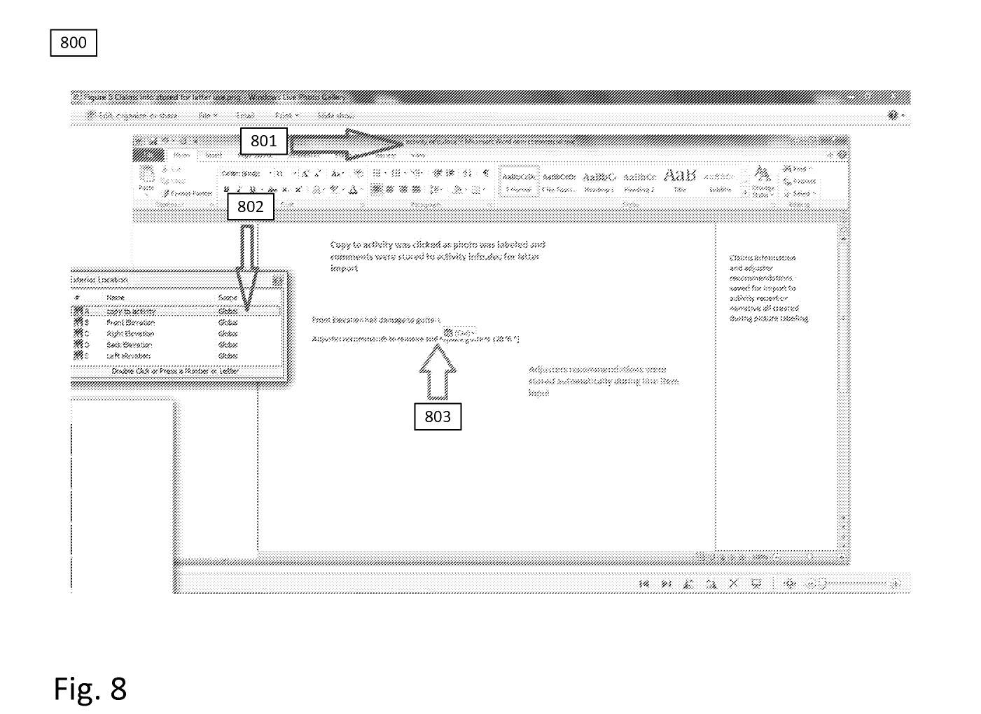

With reference now to FIG. 8, the interface 800 shows what would be presented to the user after the user had labeled all pictures and selected all relevant repair options for a particular claim. When the user completed labeling the claim's photos the “Copy to Activity” option was selected from menu 802. By selecting “Copy to Activity” document window 801 was opened and all of the information the user had input during labeling was copied into document body 803. At this point the user may also be prompted to enter additional information to complete the claims documentation process including more information about damaged items, location information, and repair recommendations. The user may also manually enter in any information not previously entered in the claims documentation process. When the user is finished, the activity information is saved to file for later import into other documents.

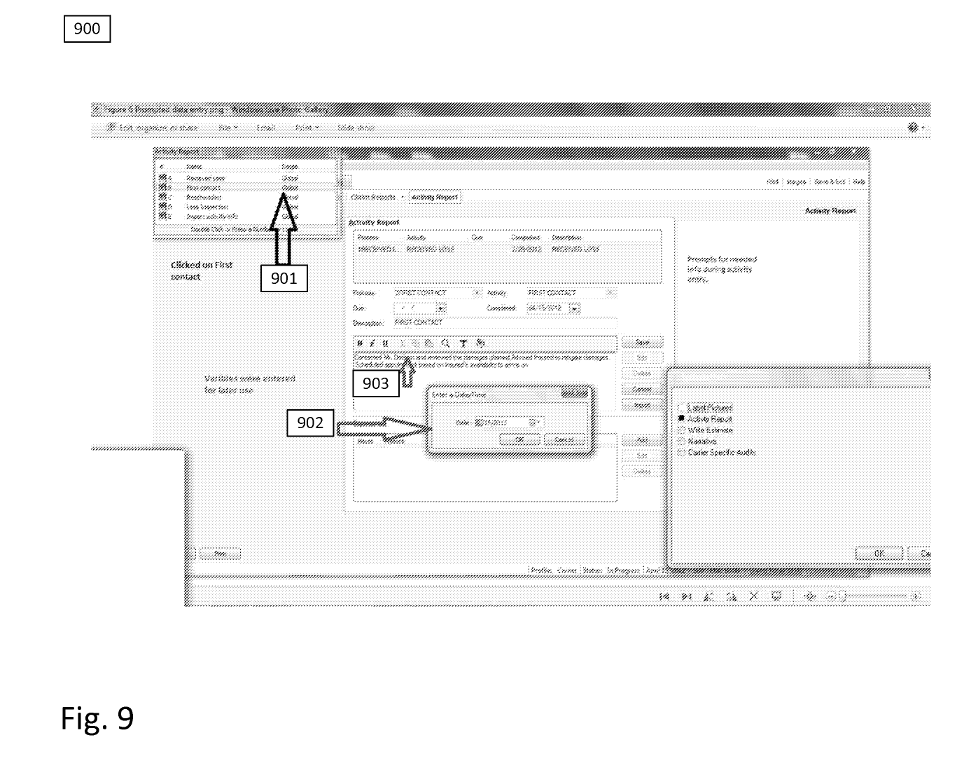

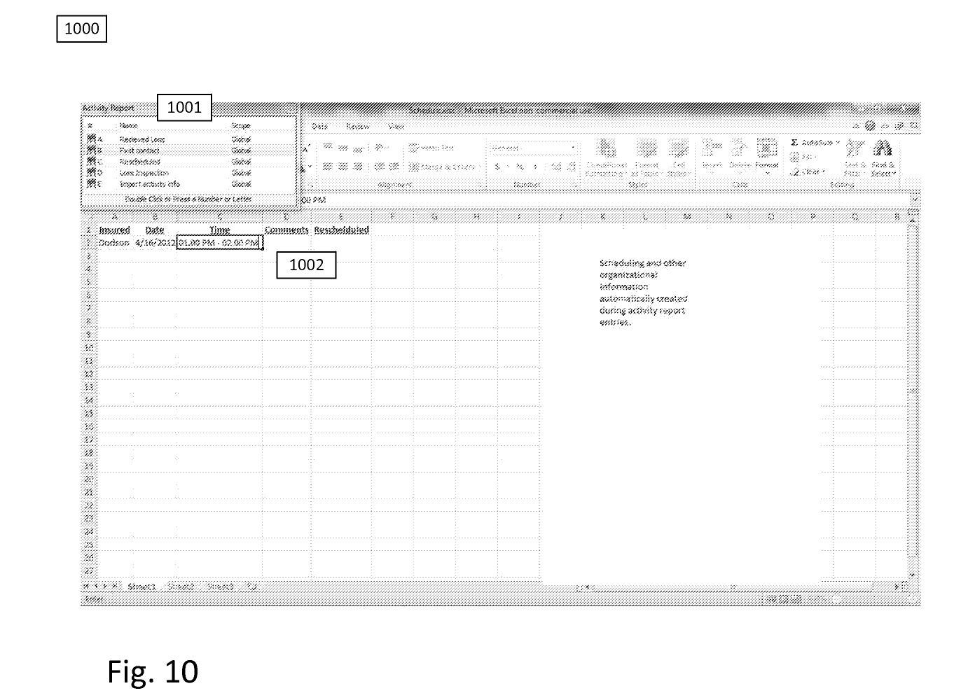

With reference now to FIG. 9, the interface 900 provides data fields and data entry prompts to allow the user to easily complete an activity report for a claim. The user first selects the type of activity being documented from Activity Report menu 901. In this example, the user has selected “First Contact” from the menu. The user is then presented with prompts like Date/Time prompt 902 that allow the user to easily complete the activity report. Data entry fields such as field 903 allow the user to add additional information related to the activity being documented. The user may make comments or suggestions related to the activity that will be saved to file with the activity report. The user may also be prompted to enter information such as the insured's name and gender, contractor's name and number, and the date and time of any appointments. Once the user has completed an activity report, a schedule, seen in FIG. 10, is automatically generated using the information entered in the picture labeling steps and in the activity report itself.

With reference now to FIG. 10, an interface 1000 is provided to allow the user to edit the automatically created scheduling information. The information used to generate the schedule is pulled from the picture labels and the activity report. Once generated, the user may add additional activity report items to the schedule by selecting them from the menu 1001. The user may also edit any fields to correct any mistakes or to add information, as seen in field 1002.

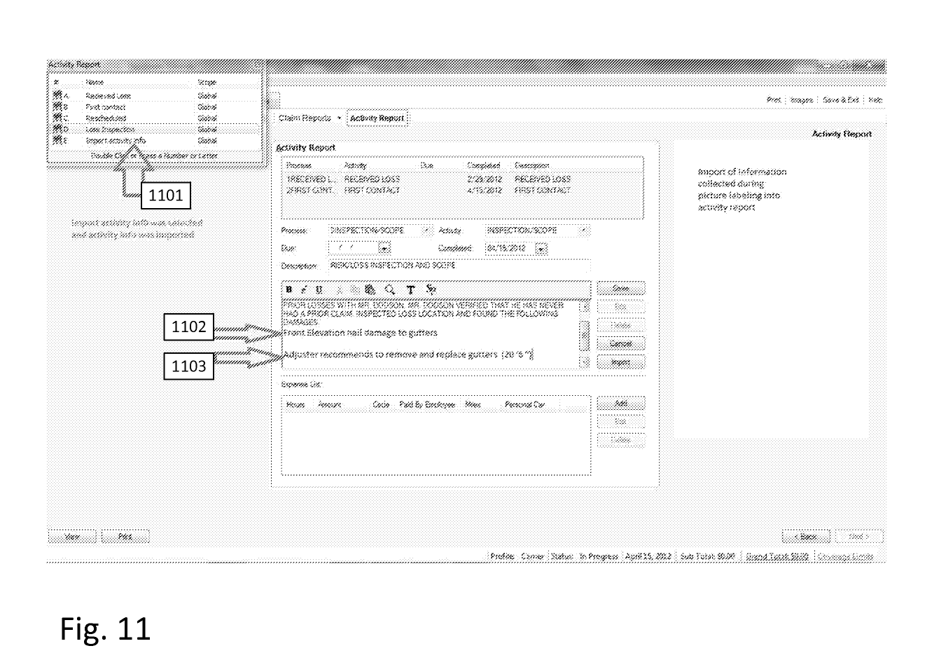

In FIG. 11, the user has reopened the activity report created in FIG. 9 and has imported the picture label information created during the labeling process. To import the picture label, the user selected “Import Activity Info” from menu 1101. The label 1102 and repair recommendation 1103 entered during the labeling process are then added to the activity report. The activity report is then saved so that it may be imported or viewed later.

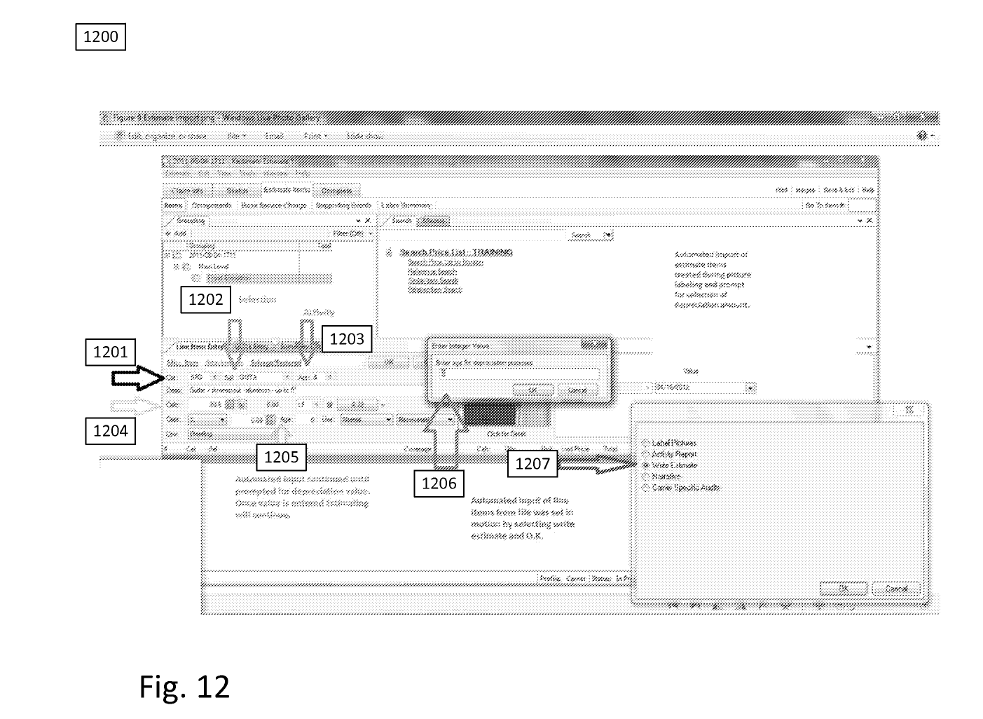

Once the activity report has been finished, the user may then create an estimate. The estimate creation interface 1200, seen in FIG. 12, is populated automatically primarily from information entered during the picture labeling and activity report steps. However, some information may not have been entered by the user at that time. The information needed for category field 1201, selection field 1202, and activity field 1203 are filled automatically from information entered in the labeling and activity report steps. However, information needed for calculation field 1204 and age field 1205 needed for the depreciation calculation will not have been previously entered, and the user will be prompted to enter this information in prompt 1206. The user may open estimate interface 1200 using menu 1207, and may also use menu 1207 to return to other segments of the interface. Once the user has provided any necessary information, the estimate is automatically generated. At this point the claims adjustment process is finished, however, the user may return to any portion of the process to add, update, or correct any information.

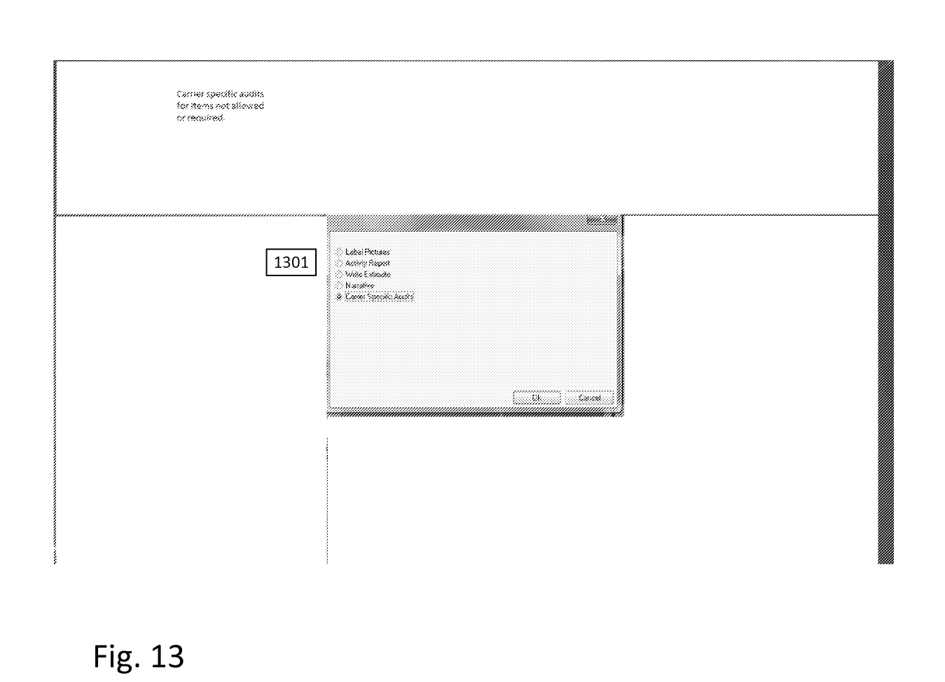

With reference now to FIG. 13, the user may also choose to go through a “Carrier Specific Audit” process that is tailored to a specific insurance carrier from menu 1301. The information needed for this process may be stored on the user's computer, or may be stored remotely, on primary server 110 for example.

Most of the information and resources needed for the process depicted in FIG. 3 through FIG. 13 is stored locally on user computer 120. However, additional databases of property times, loss types, or specific audits may be stored on the primary server 110 and attached server database 111, or on a third party database such as remote database 101. The user may save any information, estimates, reports, or labels created in the claims adjustment process locally on user computer 120, or may upload the information to primary server 110 so that it may be accessed by other claims adjusters or third parties.

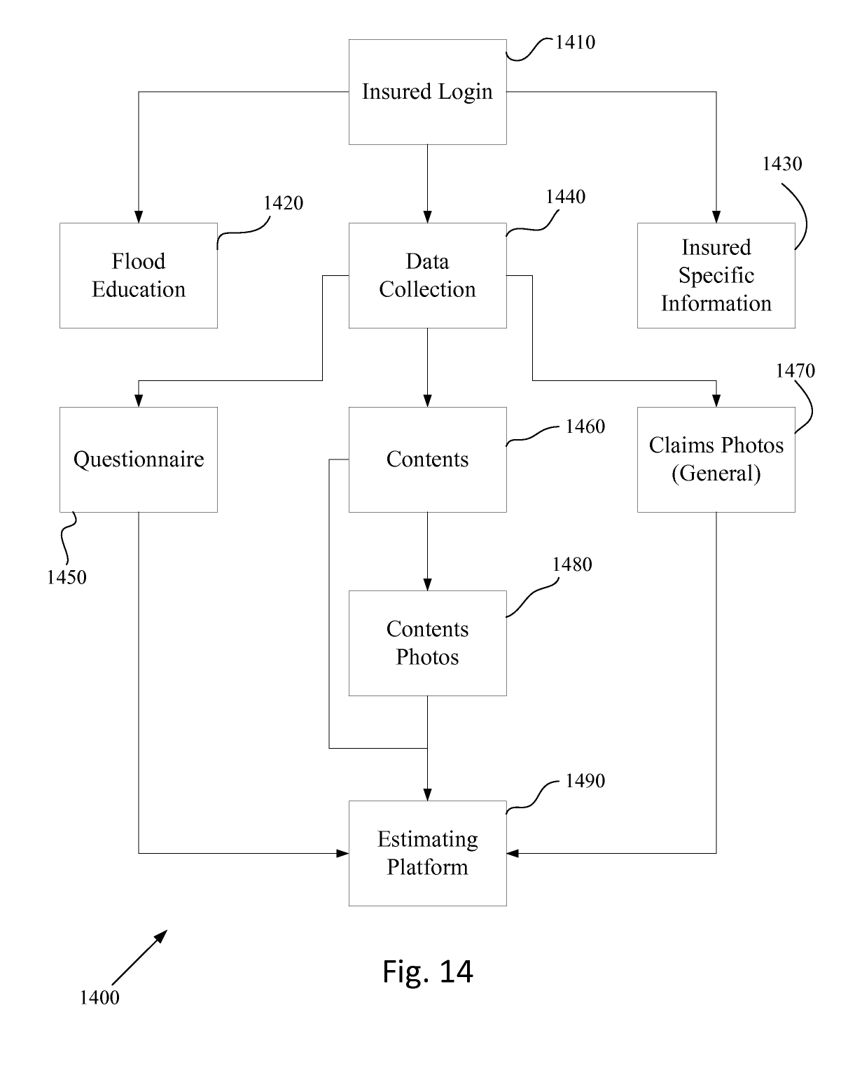

With reference now to FIG. 14, a flowchart depicts a user interface flow diagram 1400 that shows how an insured may use, in one embodiment, a web interface to both enter and receive information about their insurance policy or claim. The process begins in step 1410 wherein a user may enter a set of login credentials to access a secure account containing information related to their insurance policy and/or pending claims. From a home screen, the insured user may select from options that take them to a flood education section 1420, an insured specific information section 1430, or a data collection section 1440. The flood education section 1420 contains information relevant to floods, flood damage, flood insurance, flood insurance claims, and other general information. Depending on the nature of the insurance policy, the flood education section 1420 may be replaced by a fire education, storm education, or other similarly formatted disaster education section.

The insured specific information section 1430 provides the insured with information about their specific insurance policy or pending/outstanding claims. The information in this section is specific to both the insured and their specific policy and may change based on changes to the insured, the insured's policy, or any pending/outstanding claims.

The data collection section 1440 provides the insured with a set of tools and functions that enable the ensured to enter information about a specific insurance claim. An insured may access a questionnaire 1450, claims photos entry tool 1470, or claim contents utilities 1460. The questionnaire 1450 is used to import information supplied by the insured into claims estimating platform described herein. Information supplied in the questionnaire 1450 may also be used to auto-populate forms and automatically label photos.

The claims photos entry tool 1470 is used by the insured to enter general photos related to their insurance claim. Photos entered using this tool are automatically resized and converted into formats usable within a claims resolution document. The claim contents utilities 1460 are used by the insured to add information about their specific claim. Information may include the extent of damage, items damaged, cause of damage, information about the insured and their property, or any other information about the specific claim. The contents photos utility 1480 is used to automatically label photos as they are added or uploaded with the information supplied by the user in the claims contents utilities 1460. All information entered, added, uploaded, or supplied by the insured using the questionnaire 1450, the claims contents utilities 1460, the contents photos utility 1480, or the claims photos entry tool 1470 are sent to the estimating platform 1490. The set of information is used to automatically populate forms and label photos in the estimating platform 1490. A claims adjuster may also modify the information or add additional photos or information in the estimating platform 1490 to complete the insurance claim estimate.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A computer-implemented method comprising:
providing a first user interface comprising a first set of commands and functions;
associating a label with an individual image file using the first set of commands and functions, the label comprising a description of the image file;
storing the label in a separate file;
receiving additional information related to the image file and appending the additional information to the separate file; and
automatically generating at least one document comprising the information in the separate file.

2. The computer-implemented method of claim 1, wherein the additional information comprises at least one of scheduling information, claimant information, activity documentation, or repair options.

3. The computer-implemented method of claim 1, wherein the separate file is exported to a separate computer program.

4. The computer-implemented method of claim 1, wherein the at least one document is one of a claim estimate, an activity report, or a narrative.

5. The computer-implemented method of claim 1, further comprising automatically generating a set of scheduling information comprising at least the information in the separate file.

6. The computer-implemented method of claim 1, wherein the at least one document is formatted for an individual insurance carrier.

7. The computer-implemented method of claim 1, wherein the first set of commands and functions for associating a label with the individual image file includes a library of standardized sentence fragments and tags.

8. The computer-implemented method of claim 1, wherein the method further comprises providing a second user interface comprising a second set of commands and functions.

9. The computer-implemented method of claim 8, wherein the second set of commands and functions further comprises a data collection utility.

10. The computer-implemented method of claim 9, wherein the data collection utility comprises a questionnaire utility, a data entry utility, and an image entry utility.

11. The computer-implemented method of claim 8, wherein the second set of commands and functions comprises a user education utility.

12. A system having a server, and a computer comprising a processor, a memory, and a database, the system comprising:
a display means for providing a first user interface comprising a first set of commands and functions;
the computer configured to:
allow a user to associate a label with an individual image file using the first set of commands and functions, the label comprising a description of the image file;
store the label in a separate file;
receive additional information related to the image file and append the additional information to the separate file;
automatically generate at least one document comprising the information in the separate file; and
the database configured to store the separate file and the at least one document.

13. The system of claim 12, wherein the additional information comprises at least one of scheduling information, claimant information, activity documentation, or repair options.

14. The system of claim 12, wherein the separate file is exported to a separate computer program.

15. The system of claim 12, wherein the at least one document is one of a claim estimate, an activity report, or a narrative.

16. The system of claim 12, further comprising automatically generating a set of scheduling information comprising at least the information in the separate file.

17. The system of claim 12, wherein the at least one document is formatted for an individual insurance carrier.

18. The system of claim 12, wherein the first set of commands and functions for associating a label with the individual image file includes a library of standardized sentence fragments and tags.

19. The system of claim 12, wherein the method further comprises providing a second user interface comprising a second set of commands and functions.

20. The system of claim 19, wherein the second set of commands and functions further comprises a data collection utility.

21. The system of claim 20, wherein the data collection utility comprises a questionnaire utility, a data entry utility, and an image entry utility.

22. The system of claim 12, wherein the second set of commands and functions comprises a user education utility.
